(19) United States
(12) Patent Application Publication
(10) Pub. No.: US 2005/0069013 A1
(43) Pub. Date: Mar. 31, 2005

(54) Method and apparatus for wavelength division multiplexing

(75) Inventors: Sarvotham Bhandarkar, Allen, TX (US); Jaime Castillega, Richardson, TX (US)

Correspondence Address: DUKE W. YEE, YEE & ASSOCIATES, P.C., P.O. BOX 802333, DALLAS, TX, 75380, US

(73) Assignee: Photodigm, Inc., Richardson, TX (US)

(21) Appl. No.: 10/952,226

(22) Filed: Sep. 28, 2004

Related U.S. Application Data
(60) Provisional application No. 60/506,795, filed on Sep. 29, 2003.

(51) Int. Cl. H01S 3/08

(52) U.S. Cl. 372/102; 398/43; 372/50

(57) ABSTRACT

An apparatus and method of Wavelength Division Multiplexing (WDM) are provided. The WDM multiplexer includes a plurality of lasers, a plurality of collimating lenses and a single focusing lens. Each lens of the plurality of lenses is positioned so as to collimate a beam of light emitted by a laser of the plurality of lasers. The focusing lens is positioned to focus a plurality of collimated beams of light received from the plurality of lenses into substantially a point of light. The WDM multiplexer includes a receptacle that houses the plurality of lasers, the plurality of collimating lenses and the focusing lens.

### PROVISIONAL APPLICATION

The present invention claims benefit of priority to U.S. Provisional Patent Application Ser. No. 60/506,795 entitled “GSE Laser Enabled WDM Mux,” filed on Sep. 29, 2003, and which is hereby incorporated by reference.

### BACKGROUND OF THE INVENTION

1. Technical Field

The present invention is directed generally toward an apparatus and method for Wavelength Division Multiplexing (WDM). More specifically, the present invention is directed to a grating-coupled surface emitting (GSE) laser enabled WDM multiplexer and method of multiplexing using a GSE WDM multiplexer.

2. Description of the Related Art:

FIG. 1 is an exemplary diagram of a known 10 GbE LX4 multiplexer (see IEEE standard P802.03ae) which is used to multiplex different wavelengths of light into a single multiplexed beam that is output via a fiber ferrule. As shown in FIG. 1, in this known architecture, the LX4 multiplexer includes an edge emitting laser array 110 in which edge emitting lasers of different wavelength beams emit beams of light that pass through the collimating lens array 120 and filter array 130. The filter array 130 contains a plurality of filters that pass through one particular wavelength of light while other wavelengths of light are reflected by the filter array 130. The light beams that have wavelengths of light that pass through the filter array 130 enter glass block 140 which acts as a bounce cavity. The light beams entering the glass block 140 bounce down the length of the glass block 140 and exit an end of the glass block 140 and are reflected by mirror 150 toward focusing lens 160. The lens 160 focuses the light beams reflected by the mirror 150 to a focal point. In this way, the multiple light beams from edge emitting laser array 110 are multiplexed into a single beam that is output via an exit channel into which a fiber ferrule may be plugged.

The above architecture for a 10GbE LX4 multiplexer permits combining or separating a plurality of light signals. However, this architecture has a number of drawbacks. The light beams emitted from the edge emitting laser array 110 lose power as they pass through the collimating lens array 120, the filter array 130 and bounce down the bounce cavity provided by the glass block 140. This means that to compensate for this loss in power, the light beams emitted from the edge emitting laser array 110 must have a higher initial intensity resulting in a large power requirement for the edge emitting laser array 110.

Moreover, as shown in FIG. 1, the light beam having a first wavelength λ₁ loses more power as it traverses the bounce cavity of the glass block 140 than the other wavelengths of light since the first wavelength light beam must perform more “bounces” down the bounce cavity with power loss at each “bounce.” As a result, the first wavelength λ₁ light beam needs to be of a higher intensity than the second and higher wavelength light beams. Similarly, the second wavelength light beam must have a higher initial intensity than the third and higher wavelength light beams, and so on. Thus, the edge emitting lasers in the edge emitting laser array 110 must have different power requirements in order to provide different intensity light beam signals.

FIGS. 2A-2C show other configurations of known edge emitting laser based multiplexers. FIG. 2A illustrates a known configuration of an edge emitting laser multiplexer in which the light beam signals from the edge emitting lasers 210 are passed through fiber optic lines 220 to a series of discrete fiber couplers 230 which couple two light beams together. FIG. 2B illustrates a known configuration of an edge emitting laser multiplexer in which laser diode array 240 outputs light signals down channels 250 in waveguide multiplexer 260 which couples the light signals into a single channel 270 that passes through fiber pigtail in V-groove chip 280. FIG. 2C illustrates a known configuration of an edge emitting laser multiplexer similar to that illustrated in FIG. 1 above. As shown in FIG. 2C, the edge emitting lasers 290 emit light beam signals through lens array 292 and filter array 294. The light beam signals that pass through the filter array 294 are bounced by the mirror 296 and filter array 294 until they are focused by focusing lens 298 into fiber 299.

In each of these configurations, large losses in signal power are experienced through the light signal travel path. These losses result in a low coupling efficiency of the light beam signals. For example, for the configurations shown in FIGS. 2A and 2B, the maximum coupling efficiency is estimated to be 30% or less while the coupling efficiency for the configuration shown in FIG. 2C is estimated to be at best 60%.

Another disadvantage of the prior art is the need for several assembly steps, many of which require active alignment, in order to obtain sufficient coupling efficiencies. The prior art has many piece parts that need to be assembled. This results in a relatively large piece-part costs and assembly costs. Thus, it would be beneficial to have an improved apparatus and method for Wavelength Division Multiplexing in which there are lower power losses in the travel path of the light beam signals and the efficiency of the light beam signal coupling is improved while achieving a lower cost multiplexer assembly.

### SUMMARY OF THE INVENTION

The present invention provides a system, apparatus and method of Wavelength Division Multiplexing (WDM) in which the coupling efficiency is increased and sensitivity to offset of the lasers from an optimum position is made less sensitive. With the present invention, a WDM multiplexer includes a plurality of lasers, a plurality of collimating lenses and a single focusing lens. The term “laser” as it is used in the present description refers to semiconductor lasers rather than the large conventional solid state lasers. Examples of semiconductor lasers include edge emitting lasers, grating-coupled surface emitting (GSE) lasers, and the like.

Each lens of the plurality of lenses is positioned so as to collimate a beam of light emitted by a laser of the plurality of lasers. The focusing lens is positioned to focus a plurality of collimated beams of light received from the plurality of lenses into substantially a point of light. This point of light is a multiplexed light beam signal that is a combination of the individual light beam signals generated by the lasers in the plurality of lasers.

The WDM multiplexer includes a receptacle that houses the plurality of lasers, the plurality of collimating lenses and the focusing lens. The receptacle includes a ferrule sleeve for coupling the point of light to an optical fiber or fiber optic connector. The collimating lenses and focusing lens may be integrated with the receptacle such that they are fashioned as a single unit. Furthermore, at least one laser of the plurality of lasers, at least one lens of the second plurality of lenses, and the focusing lens are arranged in a confocal configuration.

The plurality of lasers may comprise any number of lasers and any configuration of lasers. For example, in one embodiment of the present invention, the plurality of lasers comprises an n-by-n array of lasers, such as a 2-by-2 rectangular array of lasers. Similarly, the plurality of collimating lenses may be an n-by-n array of lenses, such as a 2-by-2 rectangular array of collimating lenses. In another embodiment, the plurality of lasers is a radial array of lasers having 8 lasers in the radial array. Similarly, with this embodiment, the plurality of collimating lenses may be a radial array of 8 lenses.

The WDM multiplexer may further include one or more monitor photodetectors. The one or more monitor photodetectors may be coupled to one or more lasers of the plurality of lasers so as to monitor an energy output from the one or more lasers. The one or more photodetectors may be integrated into one or more of the lasers. Alternatively, the one or more photodetectors may be provided separate from the one or more lasers and be operable to receive a backside emission or edge emission of energy from the one or more lasers.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a diagram of a known LX4 multiplexer configuration;

FIGS. 2A-2C are diagrams of other known light beam signal multiplexer configurations;

FIGS. 3A and 3B are exemplary diagrams showing the difference in light beam dispersion between a GSE laser and a DFB edge emitting laser;

FIG. 4 is an exemplary diagram of a plot of the coupling efficiency versus laser offset from optimum for a GSE laser implemented version of the LX4 multiplexer shown in FIG. 1;

FIG. 5 is an exemplary diagram illustrating a WDM multiplexer configuration in accordance with one exemplary embodiment of the present invention;

FIG. 6 is an exemplary diagram illustrating a WDM multiplexer configuration in which monitor photodiodes are provided in accordance with one exemplary embodiment of the present invention;

FIG. 7 is an exemplary diagram illustrating the layers of a WDM multiplexer package in accordance with one exemplary embodiment of the present invention;

FIGS. 8A-8C are exemplary diagrams showing a cutaway view of a WDM multiplexer package, a bottom view of the molded receptacle and an isometric view of the WDM multiplexer package according to one exemplary embodiment of the present invention;

FIGS. 9A and 9B are exemplary diagrams illustrating two possible configurations for permitting light beams from the GSE lasers to become incident on monitor photodiodes in accordance with exemplary embodiments of the present invention;

FIGS. 10A and 10B are exemplary diagrams illustrating the laser light beams before they pass through the focusing lens and after they pass through the focusing lens in accordance with one exemplary embodiment of the present invention;

FIG. 11 is an exemplary diagram illustrating a plot of the coupling efficiency versus laser offset for an exemplary embodiment of the present invention;

FIG. 12A-12C are exemplary diagrams of an alternative arrangement of GSE lasers and lenses in accordance with an alternative embodiment of the present invention; and

FIG. 13 is an exemplary diagram illustrating a cut-away view of a WDM multiplexer package in accordance with the alternative embodiment shown in FIG. 12.

### DETAILED DESCRIPTION

As mentioned above, known Wavelength Division Multiplexing (WDM) multiplexers experience large losses due to the media, filters, etc. through which the light beam signals must travel while being multiplexed together to form a single beam output. It would be beneficial to reduce these losses to achieve a multiplexer with a higher coupling efficiency. It would further be beneficial to have a multiplexer whose coupling efficiency is less sensitive to offsets of the lasers from their optimum position. The present invention provides WDM multiplexer configurations that achieve these objectives as discussed hereafter.

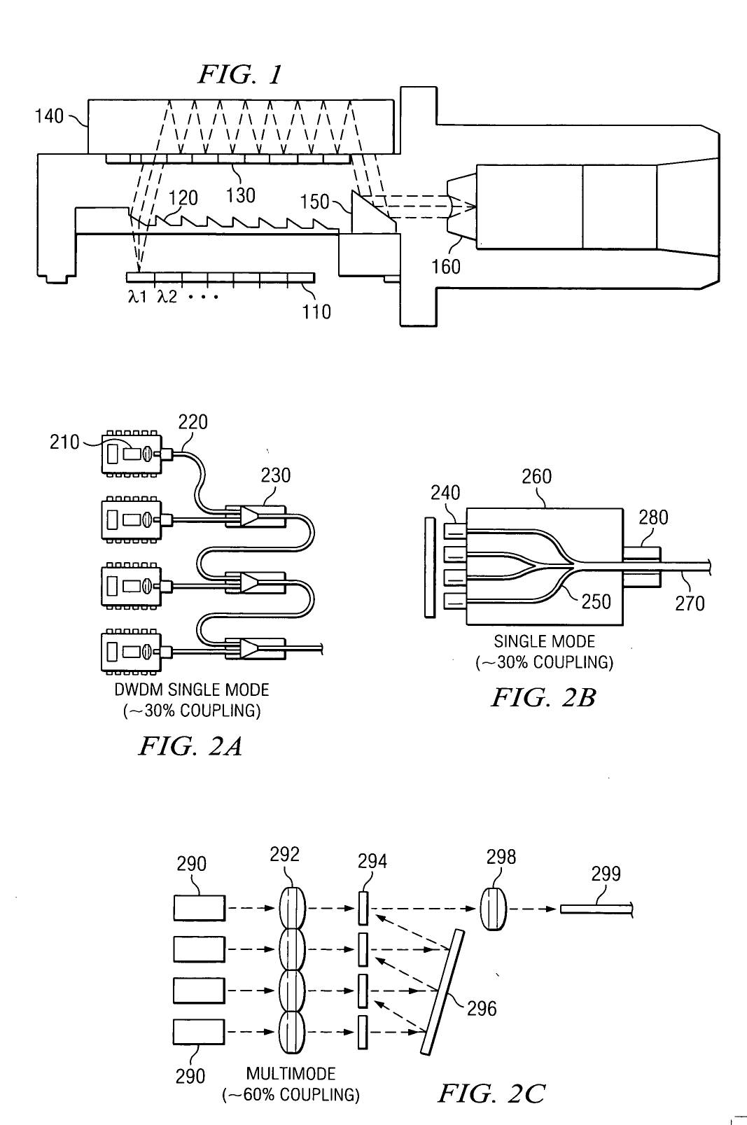

As discussed above, the known multiplexer configuration shown in FIG. 1, and the similar configuration shown in FIG. 2C, achieve a coupling efficiency of approximately 60% meaning that 60% of the incident energy from the original beams is coupled into the output fiber, the rest being lost. Thus, a first attempt to achieve higher coupling efficiency and lower sensitivity to laser position offsets may be based on attempting to improve the configurations shown in FIGS. 1 and 2C. One type of improvement may be to replace the edge emitting lasers of the known configurations with grating-coupled surface emitting (GSE) lasers which are known to have a lower beam divergence. Details regarding GSE lasers may be found in commonly assigned U.S. Pat. No. 6,760,359 B2, issued to Evans, entitled “Grating-Outcoupled Surface-Emitting Lasers with Flared Gain Regions”, issued on Jul. 6, 2004, and herein incorporated by reference.

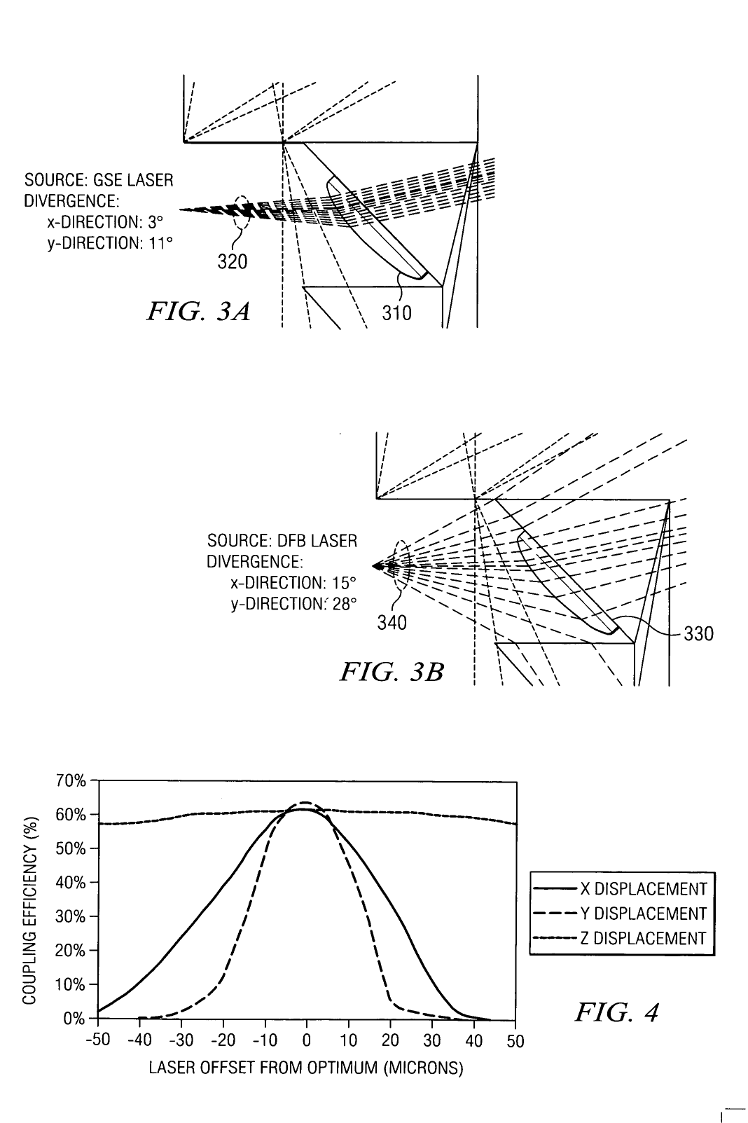

FIGS. 3A and 3B illustrate the difference in beam divergence between a GSE laser and a distributed feedback (DFB) laser, such as the edge emitting lasers of the known configuration. As shown in FIG. 3A, with a GSE laser, since there is less divergence of the beam, a lens 310 is able to capture all of the beam 320. With a DFB laser, such as shown in FIG. 3B, because the divergence is much larger than the GSE laser, the lens 330 is unable to capture the entire DFB beam 340. Thus, as a result, the DFB beam experiences larger losses as well as requires additional packaging, e.g., v-groove and lens, to properly align and couple the DFB beam into the multiplexer. As shown in FIGS. 3A and 3B, the divergence of the GSE laser in the x and y directions is 3 degrees and 11 degrees, respectively, while in the DFB laser the divergence is 15 degrees and 28 degrees, respectively. Thus, one possible improvement to the known configurations is to make use of a GSE laser in the known configurations. For example, rather than using edge emitting lasers in the laser array 110 of the configuration shown in FIG. 1, GSE lasers may be utilized.

However, it has been determined that replacing the edge emitting laser configuration of FIG. 1 with GSE lasers does not actually improve the coupling efficiency of the WDM multiplexer appreciably. FIG. 4 is an exemplary diagram of a plot of the coupling efficiency versus laser offset from optimum for a GSE laser implemented version of the LX4 multiplexer shown in FIG. 1. As shown in FIG. 4, the maximum coupling efficiency achieved by this configuration is approximately 63% coupling efficiency into the multimode fiber. This indicates that most of the loss in coupling efficiency is due to other factors in the configuration other than the laser beam divergence.

It has also been determined that the last channel coupling, i.e. the last wavelength light signal to be coupled by the multiplexer, may be up to 35% lower than the first channel light signal due to losses from multiple bounces in the bounce cavities. With each bounce a fraction of power is lost due to absorption by the filter and other loss mechanisms at the bounce interfaces.

The present invention provides a WDM multiplexer configuration that eliminates much of the loss in coupling efficiency and provides a configuration that is less sensitive to offsets of the lasers from an optimal position. The present invention uses a plurality of semiconductor lasers, e.g., GSE lasers, to provide the light beam signals with these light beam signals being multiplexed through a series of lenses that focus the light from the semiconductor lasers into a single light beam signal. The preferred embodiments of the present invention will be described in terms of using GSE lasers although it should be appreciated that the present invention may also make use of other types of lasers including edge emitting lasers and other types of semiconductor lasers without departing from the spirit and scope of the present invention.

With the configuration of the present invention, the coupling efficiency of the WDM multiplexer is increased by approximately 23% with the sensitivity of the laser placement being negligible up to approximately an 8 micron offset from the optimal position. As a result, it is likely that with the present invention, active positioning of the lasers may be avoided during packaging of the WDM multiplexer.

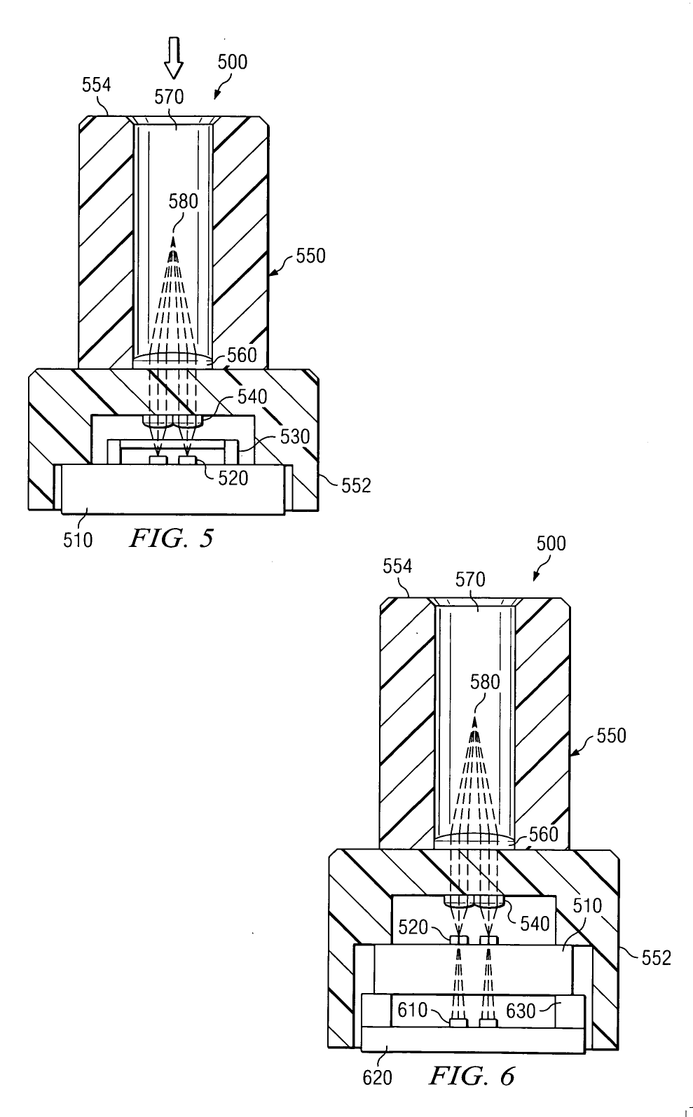

FIG. 5 is an exemplary diagram illustrating a WDM multiplexer configuration in accordance with one exemplary embodiment of the present invention. As shown in FIG. 5, the WDM multiplexer 500 includes a substrate 510 upon which are positioned an array of GSE lasers 520 in a hermetic enclosure 530. In one exemplary embodiment, the array of GSE lasers 520 is a 2×2 array in which four GSE lasers 520 are provided for generating light beam signals at four different wavelengths that are to be multiplexed together.

Also provided is an array of collimating lenses 540 that are provided in receptacle 550. The receptacle 550 may be formed from any suitable material. In an exemplary embodiment, the receptacle 550 is formed from a molded plastic material, such as GE Ultem, that does not absorb the light beam signals emitted by the array of GSE lasers 520 with the collimating lens array 540 being positioned to align with the array of GSE lasers 520. The receptacle 550 has a wider portion 552 in which the substrate 510, the array of GSE lasers 520, and the hermetic enclosure 530, are enclosed. A narrower portion 554 of the receptacle 550 provides a mechanism for connecting the WDM multiplexer 500 to a fiber optic connector (not shown) that carries the multiplexed signal to the outside world.

Returning to the discussion of the collimating lens array 540, in the depicted exemplary embodiment there is one collimating lens in the collimating lens array 540 for each GSE laser in the array of GSE lasers 520. Thus, in an exemplary embodiment, the collimating lens array 540 is a 2×2 array of collimating lenses that are positioned such that each lens in the collimating lens array 540 is aligned with a respective one of the GSE lasers in the 2×2 array of GSE lasers 520.

Also provided in the receptacle 550 is a single focusing lens 560. The single focusing lens is provided at a position within the receptacle 550 at one end of a channel 570 formed in the receptacle 550. At the opposite end of the channel 570, a fiber-optic connector (not shown), such as a SC connector, may be coupled to the WDM multiplexer 500. Both the collimating lens array 540 and the single focusing lens 560 may be integrated into the receptacle 550 such that the collimating lens array 540, the single focusing lens 560 and the receptacle 550 may be fabricated as a single unit. The collimating lens array 540 and single focusing lens 560 are cut into the molding cavity along with the other features. The cavity is then injected with molten plastic forming the receptacle and lenses as a single piece. An optically transparent material, such as GE Ultem, is used in this case. At least one GSE laser of the array of GSE lasers 520, at least one lens of the collimating lens array 540, and the focusing lens 560 are arranged in a confocal configuration.

In operation, the GSE lasers in the array of GSE lasers 520 emit light beam signals through the hermetic enclosure 530, which is transparent to the light beam signals. These light beam signals are captured by the collimating lenses of the collimating lens array 540. Since there is a one to one correspondence between GSE lasers and collimating lenses in the arrays 520 and 540, each collimating lens captures the light beam signal from its corresponding GSE laser. As shown in FIG. 5, the collimating lenses adjust the direction of the light beam signals from being divergent, i.e. spreading, to a direction that is parallel with the axis of the lenses (the vertical straight lines illustrated in FIG. 5). This redirects the light beam signals so that they are caught by the single focusing lens 560. Transmission from the collimating lens array 540 and focusing lens 560 is within the material of the molded receptacle 550 which is transparent at the operating wavelengths.

The focusing lens 560 receives the light beam signals from all of the collimating lenses in the collimating lens array 540 and multiplexes them into a single light beam signal. Essentially, the focusing lens 560 focuses each of the light beam signals to a focal point 580 causing the light beam signals to be combined and multiplexed into a single light beam signal. This single light beam signal generated by the focusing lens 560 travels down the channel 570 so that it may pass to a fiber optic connector (not shown) for transmission through a fiber optic medium or the like. The primary application of this embodiment of the present invention is to provide 10 Gigabit Ethernet capability over 300 meters in accordance with IEEE 802.3ae—LX4 standard. Thus, the WDM multiplexer 500 may be utilized to provide multimode 10 Gigabit Ethernet data communication using multiplexed light beam signals.

FIG. 6 is an exemplary diagram illustrating a WDM multiplexer configuration in which monitor photodiodes are provided in accordance with one exemplary embodiment of the present invention. The main difference between this embodiment and the previous embodiment of FIG. 5 is the inclusion of monitor photodetectors or photodiodes 610 on a photodetector/photodiode substrate 620 and positioned on an opposite side of the substrate 510 offset from the substrate 510 by interposer 630. It will be assumed for purposes of this description that the photodetectors are photodiodes although other embodiments of the present invention may make use of different types of photodetectors from those illustrated herein. There is a separate monitor photodiode 610 for each of the GSE lasers in the array of GSE lasers 520 and the monitor photodiodes are positioned on the photodiode substrate 620 so as to be aligned with their corresponding GSE laser. The monitor photodiodes 610 are used to monitor the light beam signal output of the GSE lasers in order to determine the degradation of the GSE lasers over time and compensate for this degradation. The monitor photodiodes 610 receive backside emissions from the GSE lasers, monitor these backside emissions and provide indications of the degradation of the light beam signal to a control circuit that maintains the power output of the lasers at a constant level.

Although FIG. 6 illustrates the monitor photodiodes 610 being on a separate substrate 620 from the substrate of the GSE lasers, the present invention is not limited to such a configuration. To the contrary, the monitor photodiodes may be integrated within the GSE substrate or GSE die, and may monitor the actual light beam signal output of the GSE lasers rather than the backside emission of the GSE lasers. Thus, rather than being separated from the GSE lasers, the photodetectors or photodiodes 610 may be integrated into the GSE lasers. The integrated photodiodes are fabricated as part of the laser, as an extension of the laser ridge, and monitor a portion of the light in the main lasing cavity. An alternate method of monitor photodiode implementation is similar to conventional edge emitter techniques, where the photodiode is separate from the laser, and monitors the edge emission of the GSE ridge.

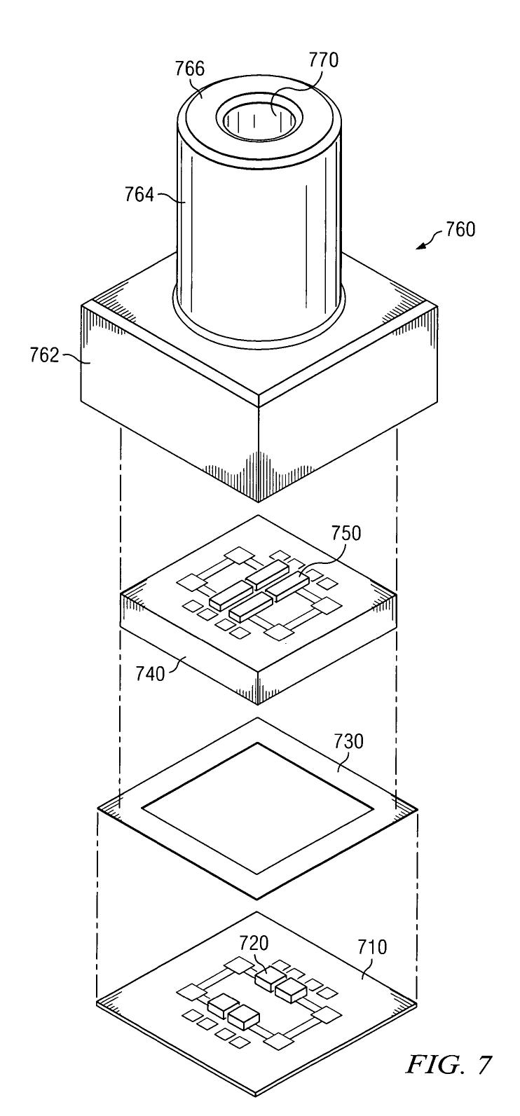

FIG. 7 is an exemplary diagram illustrating the layers of a WDM multiplexer package in accordance with one exemplary embodiment of the present invention. The embodiment illustrated in FIG. 7 represents an embodiment in which the monitor photodiodes are provided on a separate substrate from that of the GSE lasers. However, as stated above, the present invention is not limited to such and other embodiments may be provided that integrate the monitor photodiodes into the same die as the GSE lasers or monitor edge emission.

As shown in FIG. 7, the WDM multiplexer package includes the monitor photodiode substrate 710 upon which a plurality of monitor photodiodes 720 are positioned. An interposer 720 is provided atop the monitor photodiode substrate 710 for spacing the monitor photodiode substrate 710 from the GSE laser substrate 740. The monitor photodiode substrate 710 and the GSE laser substrate 740 may be formed as a silicon substrate or other suitable material. Alternatively, the substrates may be Aluminum Oxide (Alumina) patterned substrates in which circuit patterns may be etched. The GSE lasers 750 are provided on the GSE laser substrate 740 and the entire package is housed in the receptacle 760. The receptacle 760, as discussed above, has the lens array and single focusing lens integrated therein in the wider section 762 of the receptacle 760. The focusing lens is positioned at one end of the cylindrical section 764 of the receptacle 760 closest the lens array and the GSE lasers with a channel 770 being provided in the cylindrical section 764. A fiber optic connector and/or optical fiber may be connected to the WDM multiplexer package at an opposite end 766 of the channel 770 from the focusing lens.

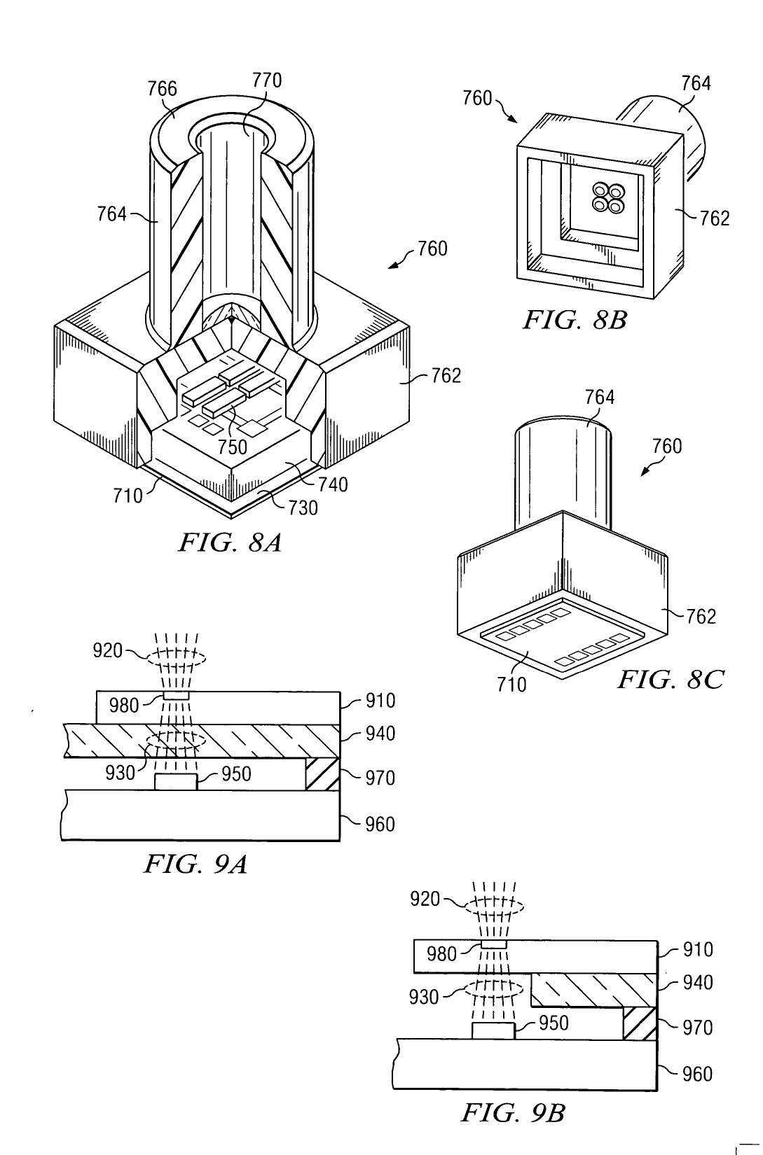

FIGS. 8A-8C are exemplary diagrams showing a cutaway view of a WDM multiplexer package, a bottom view of the receptacle and an isometric view of the WDM multiplexer package according to one exemplary embodiment of the present invention. Elements in FIG. 7 that are shown in each of the FIGS. 8A-8C are identified with similar reference numerals as shown in FIG. 7.

FIGS. 9A and 9B are exemplary diagrams illustrating two possible configurations for permitting light beams from the GSE lasers to become incident on monitor photodiodes in accordance with exemplary embodiments of the present invention. FIG. 9A illustrates an arrangement in which the GSE laser substrate is transparent to the laser light wavelengths of the GSE lasers. As shown in FIG. 9A, a GSE laser 910 emits a light beam 920 toward the collimating lens array while a backside light beam emission 930 is emitted towards the GSE laser die attach substrate 940. These light beams 920 and 930 are emitted from an outcoupler region 980 of the GSE laser 910. The backside light beam emission 930 falls incident on the monitor photodiode 950 which measures characteristics, such as intensity, of the backside light beam emission 930. The monitor photodiode 950 is provided on monitor photodiode attach substrate 960 and is spaced from the GSE laser die attach substrate 940 by an interposer 970. The area between the GSE laser die attach substrate 940 and the monitor photodiode attach substrate 960 is allowed to be filled with air, vacuum or any other optically transparent media.

FIG. 9B illustrates an alternative arrangement in which the GSE laser 910 overhangs the GSE laser die attach substrate 920 such that there is no substrate between the outcoupler region 980 on the GSE laser 910 from which the backside light beam 930 is emitted. In this way, the GSE laser die attach substrate 920 may be made from a material that is non-transparent to the GSE laser light wavelengths yet the backside light beam 930 emission still falls incident on the monitor photodiode 950 since the GSE laser die attach substrate 920 is not present in the backside light beam path. This overhang may be provided as openings in the GSE laser die attach substrate 920 that are positioned so as to be in alignment with an outcoupler region 980 on the GSE laser 910.

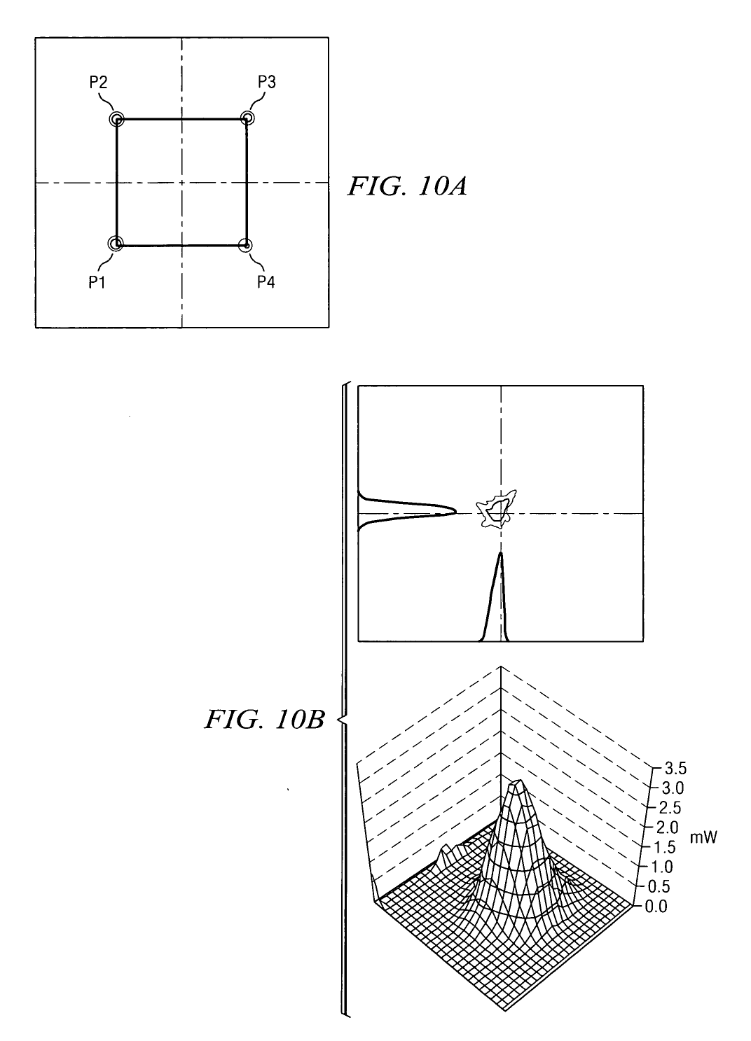

FIGS. 10A and 10B are exemplary diagrams illustrating infrared camera images of the laser light beams before they pass through the focusing lens and after they pass through the focusing lens in accordance with one exemplary embodiment of the present invention. The illustrations in FIGS. 10A and 10B are for a WDM multiplexer configuration in which there are four GSE lasers whose light beam signals are to be multiplexed together to form a single light beam signal.

As shown in FIG. 10A, the four light beam signals from the GSE lasers are separate light beam signals at positions P1-P4. The GSE lasers and thus, the light beam signals are positioned in a rectangular configuration in which the sides of the square are approximately 500 microns. Preferably, the position of the GSE lasers and the light beam signals are within 5 microns of the target spacing of 500 microns.

As shown in FIG. 10B, after the light beam signals pass through the focusing lens, the light beam signals are multiplexed together into a single light beam signal. A three dimensional intensity plot for this multiplexed light beam signal is provided below the infrared camera image.

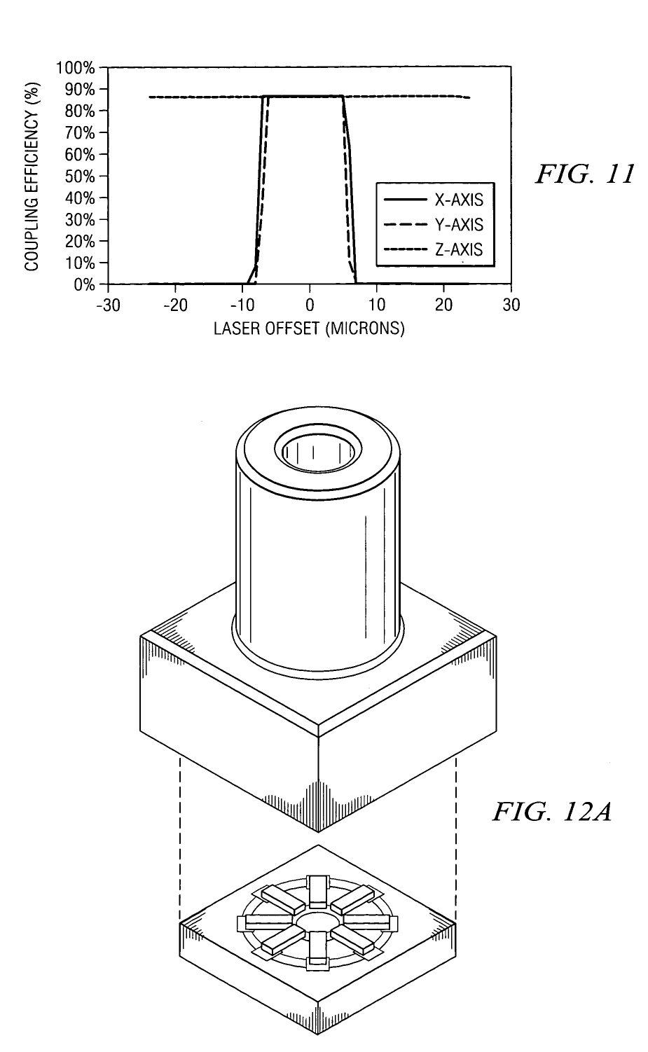

FIG. 11 is an exemplary diagram illustrating a plot of the coupling efficiency versus laser offset for an exemplary embodiment of the present invention. As shown in FIG. 11, the present invention achieves approximately a maximum coupling efficiency into the multimode optical fiber of 86%. This coupling efficiency may be improved further through use of other optimizations such as refining and shaping the lenses of the WDM multiplexer package. Comparing this coupling efficiency with that of the known configurations, when modified to include GSE lasers, shown in FIG. 4, the present invention achieves at least a 23% increase in coupling efficiency over these modified known systems. Furthermore, the present invention achieves at least a 26% increase in coupling efficiency with regard to unmodified known systems which only achieve approximately a 60% coupling efficiency.

Moreover, as shown in FIG. 11, the coupling efficiency remains approximately the same within an 8 micron offset of the optimal position of the GSE lasers. This means that the present invention is relatively insensitive to errors in placement of the GSE lasers when those errors are within 8 microns of the optimal position. As a result, active placement of the GSE lasers may not be necessary when manufacturing the WDM multiplexer package and a less time consuming and expensive manufacturing process using a pick and place machine may be utilized. The known configuration shows approximately an 8% loss in coupling efficiency when the offset of the laser is 8 microns from the optimal position.

Thus, the present invention provides a WDM multiplexer package and method that results in a multiplexer and method of multiplexing that achieves a higher coupling efficiency and is less sensitive to placement errors of the lasers than known configurations. In addition, the present invention permits components, e.g., the collimating lenses, the focusing lens and the ferrule sleeve, of a WDM multiplexer to be combined into a single molded unit, thereby lowering piece-part costs and assembly costs. In addition, other components that are typically found in known WDM multiplexers are eliminated in the present invention, e.g., the filter array 130 and bounce cavity 140 in FIG. 1, which results is lower piece-part costs and assembly costs.

While the above exemplary embodiments of the present invention have been described in terms of a four GSE laser array configured in a square configuration, the present invention is not limited to such. Rather, other configurations of the GSE laser array, collimating lens array, and monitor photodiodes may be used without departing from the spirit and scope of the present invention. Basically, any number and arrangement of GSE lasers, collimating lenses and monitor photodiodes is intended to be within the spirit and scope of the present invention.

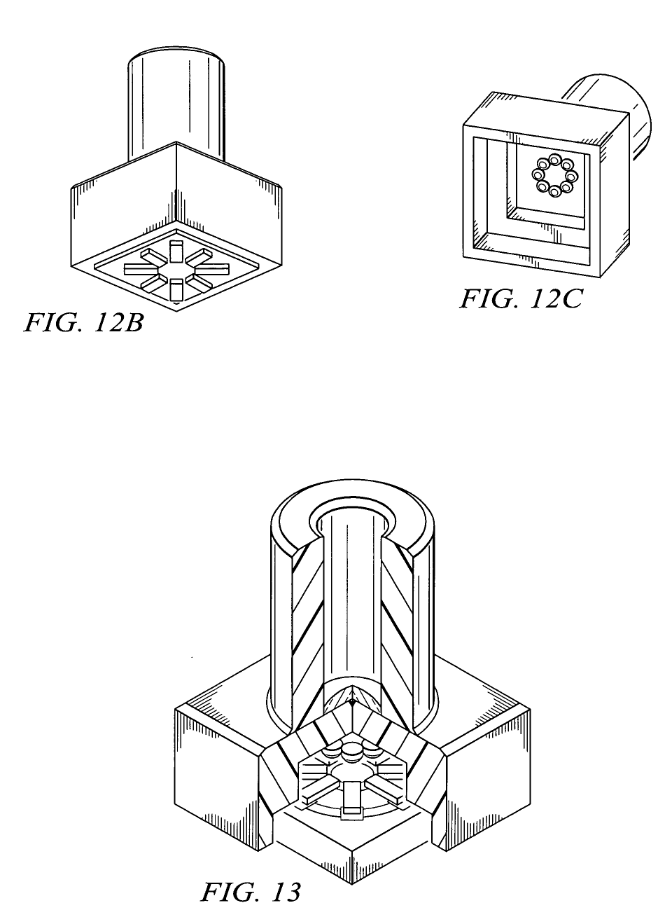

FIGS. 12A-12C are exemplary diagrams of one possible alternative arrangement of GSE lasers and lenses in accordance with an alternative embodiment of the present invention. As shown in FIGS. 12A-12C, rather than the four GSE laser array described previously, this embodiment of the present invention utilizes an array of 8 GSE lasers configured in a radial arrangement. Since the collimating lenses and monitor photodiodes are to be in alignment with the GSE lasers, the same number and arrangement of collimating lenses and monitor photodiodes as that of the GSE lasers is provided in this alternative embodiment. This embodiment permits 8 different light beam signals having 8 different wavelengths to be multiplexed together into a single light beam signal that is output to an optical fiber. As will be readily apparent to those of ordinary skill in the art, other numbers of GSE lasers, collimating lenses and monitor photodiodes, as well as other arrangements of these elements, may be used without departing from the spirit and scope of the present invention. Thus, an n×n array of GSE lasers, collimating lenses and monitor photodiodes having any of a number of different arrangements may be used without departing from the spirit and scope of the present invention.

FIG. 13 is an exemplary diagram illustrating a cut-away view of a WDM multiplexer package in accordance with the alternative embodiment shown in FIG. 12. FIG. 13 is similar to FIG. 8 but illustrates the cutaway of the alternative embodiment shown in FIG. 12. The same basic arrangement of layers is illustrated in FIG. 13 as is shown in FIG. 8 with the difference being primarily in the number and arrangement of the GSE lasers, the collimating lenses and the monitor photodiodes.

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

1. A laser-enabled multiplexing system, comprising:
a plurality of grating-outcoupled surface emitting (GSE) lasers;
a plurality of lenses, each lens of the plurality of lenses being positioned so as to collimate a beam of light emitted by a GSE laser of the plurality of GSE lasers; and
a focusing lens positioned to focus a plurality of collimated beams of light received from the plurality of lenses into substantially a point of light.

2. The laser-enabled multiplexing system of claim 1, further comprising:
a receptacle for coupling the point of light to an optical fiber.

3. The laser-enabled multiplexing system of claim 1, wherein at least one GSE laser of the plurality of GSE lasers, at least one lens of the second plurality of lenses, and the focusing lens are arranged in a confocal configuration.

4. The laser-enabled multiplexing system of claim 2, wherein the plurality of lenses, the focusing lens, and the receptacle are fabricated as a single unit.

5. The laser-enabled multiplexing system of claim 1, wherein the plurality of GSE lasers comprises a 2-by-2 rectangular array of GSE lasers.

6. The laser-enabled multiplexing system of claim 5, wherein the plurality of lenses comprises a 2-by-2 rectangular array of lenses.

7. The laser-enabled multiplexing system of claim 1, wherein the plurality of GSE lasers comprises an n-by-n array of GSE lasers.

8. The laser-enabled multiplexing system of claim 7, wherein the plurality of lenses comprises an n-by-n array of lenses.

9. The laser-enabled multiplexing system of claim 1, wherein the plurality of GSE lasers comprises a radial array of GSE lasers.

10. The laser-enabled multiplexing system of claim 1, wherein the plurality of GSE lasers comprises a radial array of 8 GSE lasers.

11. The laser-enabled multiplexing system of claim 1, wherein the plurality of lenses comprises a radial array of 8 lenses.

12. The laser-enabled multiplexing system of claim 1, further comprising:
a substrate, wherein the plurality of GSE lasers are attached to the substrate.

13. The laser-enabled multiplexing system of claim 1, wherein the multiplexing system comprises a Wavelength Division Multiplexer (WDM).

14. The laser-enabled multiplexing system of claim 1, further comprising:
at least one photodetector, wherein the at least one photodetector is coupled to at least one GSE laser of the plurality of GSE lasers so as to monitor an energy output from the at least one GSE laser.

15. The laser-enabled multiplexing system of claim 1, further comprising:
at least one photodetector, wherein the at least one photodetector is integrated into at least one GSE laser of the plurality of GSE lasers.

16. The laser-enabled multiplexing system of claim 1, further comprising:
at least one photodetector, wherein the at least one photodetector is operable to receive a backside emission of energy from at least one GSE laser of the plurality of GSE lasers.

17. An output monitor for a laser-enabled multiplexing system, comprising:
a plurality of lasers;
a substrate attached to the plurality of lasers for mounting the plurality of lasers, the substrate including a transparent portion; and
a plurality of photodetectors, each photodetector of the plurality of photodetectors being located adjacent to the transparent portion of the substrate on a side of the substrate opposite that of the plurality of lasers so as to receive a backside emission of energy from at least one laser of the plurality of lasers.

18. An output monitor for a laser-enabled multiplexing system, comprising:
a plurality of lasers, each laser of the plurality of lasers including an outcoupler region;
a substrate attached to the plurality of lasers for mounting the plurality of lasers, the substrate including a portion not attached to each outcoupler region of each laser of the plurality of lasers; and
a plurality of photodetectors, each photodetector of the plurality of photodetectors located adjacent to a corresponding outcoupler region of each laser of the plurality of lasers so as to receive a backside emission of energy from at least one laser of the plurality of lasers.

19. A method for multiplexing a plurality of laser beams, comprising the steps of:
emitting a beam of light from each grating-coupled surface emitting (GSE) laser of a plurality of GSE lasers;
collimating each beam of light emitted from each GSE laser of the plurality of GSE lasers; and
focusing the plurality of collimated beams of light into substantially a point of light.

20. A method of making a laser-enabled multiplexing system, comprising the steps of:
providing a plurality of lasers, wherein each laser of the plurality of lasers emits a beam of light;
attaching a substrate to the plurality of lasers, the substrate including a transparent portion; and
providing a plurality of photodetectors located adjacent to the transparent portion of the substrate on a side of the substrate opposite that of the plurality of lasers, wherein the photodetectors receive a backside emission of energy from at least one laser of the plurality of lasers.

21. The method of claim 20, wherein the plurality of lasers comprises a plurality of GSE lasers.

22. A method of making a laser-enabled multiplexing system, comprising:
providing a plurality of lasers, wherein each laser of the plurality of lasers emits a beam of light from an outcoupler region;
attaching a substrate to the plurality of lasers, the substrate including a portion not attached to each the outcoupler regions of each laser of the plurality of lasers; and
providing a plurality of photodetectors, each photodetector being adjacent to a corresponding outcoupler region of a laser of the plurality of lasers, wherein at least one photodetector of the plurality of photodetectors receives a backside emission of energy from at least one laser of the plurality of lasers.

23. The method of claim 22, wherein the plurality of lasers comprises a plurality of GSE lasers.

24. A method of providing a laser-enabled multiplexing system, comprising:
providing a plurality of grating-coupled surface emitting (GSE) lasers;
providing a plurality of lenses, each lens of the plurality of lenses being positioned so as to collimate a beam of light emitted by a GSE laser of the plurality of GSE lasers; and
providing a focusing lens positioned to focus a plurality of collimated beams of light received from the plurality of lenses into substantially a point of light.
